(19) United States
(12) Patent Application Publication
(10) Pub. No.: US 2025/0320919 A1
(43) Pub. Date: Oct. 16, 2025

(54) PISTON RING WITH TRAPEZOIDAL OPENING

(71) Applicants: MAHLE Automotive Technologies (China) Co., Ltd., Shanghai (CN); MAHLE International GmbH, Stuttgart (DE)

(72) Inventor: Bluse Li, Shanghai (CN)

(21) Appl. No.: 18/988,853

(22) Filed: Dec. 19, 2024

(30) Foreign Application Priority Data
Dec. 20, 2023 (CN) 202323490565.6

(51) Int. Cl. F16J 9/12; F02F 5/00

(52) U.S. Cl. CPC F16J 9/12; F02F 5/00

(57) ABSTRACT

A piston ring includes a piston ring main body with an opening, at least one trapezoidal boss disposed at one end of the opening on the piston ring main body, and at least one groove disposed at other end of the opening on the piston ring main body, the groove being shaped to correspond with the trapezoidal boss. A height of the trapezoidal boss is not greater than a depth of the groove. The piston ring main body has a width on one side of the opening that is different from a width on the opposite side of the opening, such that during engine operation, only one side surface of the trapezoidal boss contacts a corresponding side surface of the groove.

### CROSS-REFERENCE TO RELATED APPLICATION

This application claims priority to Chinese Patent Application No. CN202323490565.6, filed on Dec. 20, 2023, the contents of which is hereby incorporated by reference in its entirety.

### TECHNICAL FIELD

The utility model belongs to the technical field of automobile parts, and in particular, relates to a piston ring with a trapezoidal opening.

### BACKGROUND

With the promulgation of China VI Vehicle Emission Regulation, new requirements are put forward for emission, particularly, NOx and particulate matters are likely to be tightened in the future; and these are closely related to the initial blowby quantity and engine oil consumption. As one of the core components of an engine, an engine piston and a piston ring are facing the challenge of higher blowby quantity and engine oil consumption. The low engine oil consumption and low blowby quantity of the piston and the piston ring in the initial stage of optimization and under the durable life can better ensure the emission within the whole life cycle can meet the requirements of the emission regulation. In the prior art, as shown in FIG. 1, which is a closed-end design of a currently common gas ring, in the specific planar closed end, due to the presence of a vertical closed channel after assembling, gas and engine oil in a combustion chamber can easily pass through the channel, which is not conducive to controlling gas blowby and engine oil consumption. Therefore, a gas ring with a special-shaped end face is proposed, with the following solution:

in the prior art that an opening of a piston ring shown in FIG. 2 is set as a V shape, this triangular design solution has the following inevitable disadvantages: the size of the piston ring is necessarily matched with the size of a cylinder liner perfectly, otherwise, a slightly larger radial size of the piston ring after assembling will cause the piston ring to support the cylinder liner, resulting in an excessive friction. A slightly smaller size will lead to an excessively large opening and an excessively large blowby quantity. Even if the size is appropriate, a V-shaped groove and a triangular shape are necessarily matched with each other perfectly. Once the sizes do not match, a surface contact seal will be changed into a line seal, so that the sealing effect is greatly reduced.

However, the design scheme that two ends of the opening of the piston ring are stepped with positive and negative matching also has the problem that once the sizes are not consistent, the blowby quantity at the opening is still large.

In view of this, it is necessary to propose a piston ring that can better control the blowby quantity of the engine and the engine oil consumption.

### SUMMARY

To solve the above technical problem, the utility model provides a piston ring with a trapezoidal opening, used for being sleeved on a piston ring groove of a piston and including a piston ring main body with an opening, where the piston ring main body is processed with at least one trapezoidal boss at an end of one side of the opening, and is processed with at least one groove matched with the trapezoidal boss at an end of the other side of the opening; a height of the boss is not greater than a depth of the groove; and the piston ring has different thicknesses on two sides of the opening, so that only one side surface of the trapezoidal boss is in contact with a corresponding side surface of the groove in the operation process of an engine.

Preferably, a thickness of the piston ring is minimum at the position of the opening, and is increased to a thickness of the piston ring main body linearly at a certain position of 60° to 180° or −60° to −180°.

Preferably, the thickness of the piston ring at a boss side is less than the thickness of the piston ring main body.

Preferably, a top surface of the piston ring main body close to a side of a combustion chamber is a flat surface, and the thickness of the piston ring main body at the boss side from a lower surface to the top surface is increased linearly from the position of the opening to a certain position of 60° to 150°.

Preferably, the thickness of the piston ring at the boss side from a lower surface to a top surface is increased linearly from the position of the opening to a position of 90°.

Preferably, the thickness of the piston ring at a groove side is less than the thickness of the piston ring main body.

Preferably, a top surface of the piston ring main body close to a side of a combustion chamber is a flat surface, and the thickness of the piston ring at the groove side from a lower surface to the top surface is increased linearly from the position of the opening to a certain position of −60° to −150°.

Preferably, the thickness of the piston ring at the groove side from a lower surface to a top surface is increased linearly from the position of the opening to a position of −90°.

Preferably, the thickness of the boss is not less than half of the thickness of the piston ring main body.

Preferably, a gradual bottom surface part of the piston ring main body is obtained through grinding and electro corrosion.

Compared with the prior art, the utility model has the following advantages: due to different thicknesses of the two sides of the trapezoidal opening of the piston ring, in the operation process of the piston, a single-side seal formed by the boss and the groove not only can effectively reduce the quantity of high-pressure gas generated by the combustion chamber passing through the opening, but also can effectively prevent the engine oil from passing through the opening, thereby reducing the blowby quantity of the engine and the engine oil consumption.

### BRIEF DESCRIPTION OF THE DRAWINGS

FIG. 1 is a structural schematic diagram of a current existing piston ring (an enlarged diagram in which an upper part is a piston ring and a lower part is an opening);

FIG. 2 is a structural schematic diagram of a piston ring set as a V shape at an opening in the prior art;

FIG. 3 is a structural schematic diagram of a piston ring with a trapezoidal opening (an enlarged diagram in which an upper part is a piston ring main body and a lower part is an opening);

FIG. 4 is a structural schematic diagram of a piston ring after being subjected to an air pressure (the solid arrow is an air pressure direction, and the dotted arrow is an air flow direction); and

FIG. 5 is a structural schematic diagram of another piston ring after being subjected to an air pressure (the solid arrow is an air pressure direction, and the dotted arrow is an air flow direction).

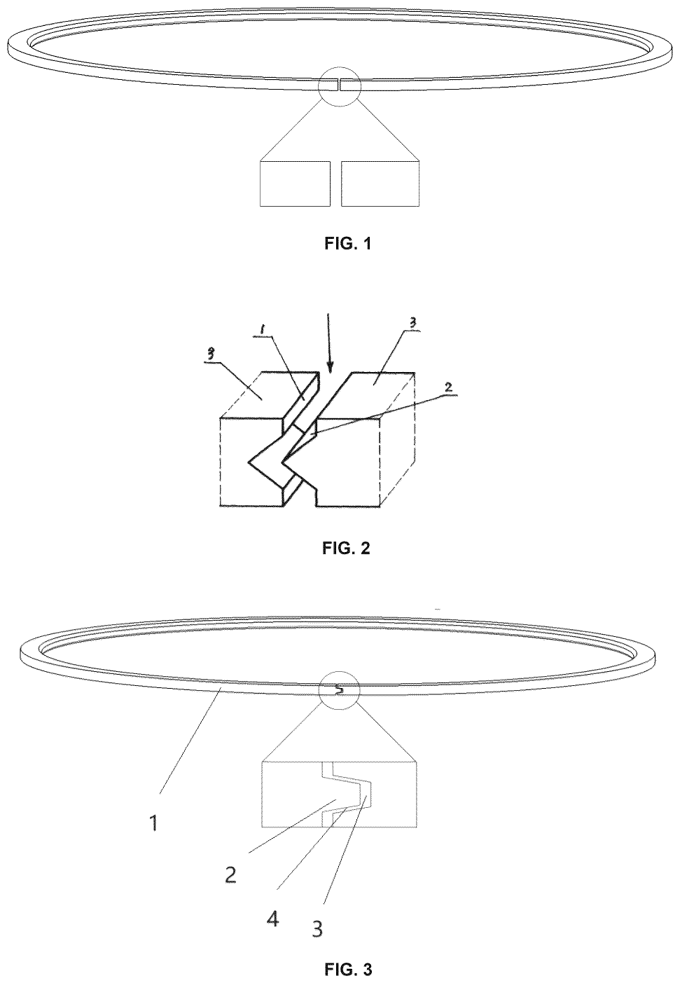

Reference numerals in the drawings: 1—piston ring main body; 2—boss; 3—groove; 4—opening.

### DETAILED DESCRIPTION

The technical solutions of the utility model are further described non- restrictively in detail below with reference to the preferred embodiments and the accompanying drawings. In the description of the utility model, it should be understood that an azimuth or position relationship indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, “circumferential” and the like is an azimuth or position relationship based on the accompanying drawings. In addition, terms “first” and “second” are used merely for description, and cannot be construed as indicating or implying relative importance or implicitly indicating a quantity of indicated technical features. Therefore, a feature defined by “first” or “second” may explicitly indicate or implicitly include at least one of such features. In the description of the utility model, “a plurality of” means at least two, for example two, three, etc., unless otherwise specifically defined. The embodiments described below with reference to the accompanying drawings are exemplary, and are only used to explain the utility model, but should not be construed as a limitation to the utility model.

### Embodiment 1

Referring to FIG. 3, a piston ring with a trapezoidal opening is used for being sleeved on a piston ring groove of a piston and includes a piston ring main body 1 with an opening 3, where the piston ring main body 1 is processed with at least one trapezoidal boss 2 at an end of one side of the opening, and is processed with at least one groove 3 matched with the trapezoidal boss 2 at an end of the other side of the opening 4; a height of the boss is not greater than a depth of the groove; and the piston ring has different thicknesses on two sides of the opening 4, so that only one side surface of the trapezoidal boss 2 is in contact with a corresponding side surface of the groove 3 in the operation process of an engine.

A thickness of the piston ring main body a boss side is less than a maximum thickness of the piston ring main body.

A top surface of the piston ring main body 1 close to a combustion chamber side is a flat surface, and the thickness of the piston ring main body at the boss side from a lower surface to the top surface is increased linearly to the maximum thickness of the piston ring main body from the position of the opening 4 to an arc length position corresponding to a 90° central angle. It is found in the actual test that taking a clockwise direction as positive, processing on the corresponding arc length within the central angle range of 60° to 180° enables the piston ring main body at the boss side to have good elasticity, and processing on the corresponding arc length in the central angle range of 90° has the comprehensive advantages in machining cost and elasticity.

The thickness of the boss 2 is not less than half of the maximum thickness of the piston ring main body 1.

A gradual bottom surface part of the piston ring main body 1 is obtained through grinding.

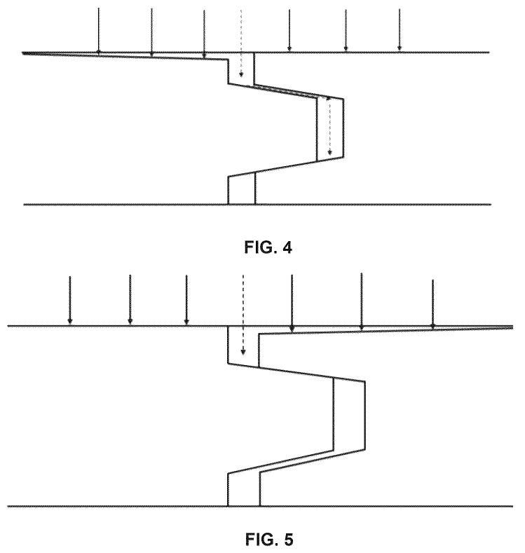

The working principle: referring to FIG. 4, after the piston ring is assembled, in the working process, when the piston ring is subjected to a pressure of a high-pressure gas from a combustion chamber, the piston ring, the piston ring is pushed to be pressed on a ring bank of a ring groove; and since one side of a protrusion 2 of the piston ring main body has a slightly smaller thickness, after being subjected to the air pressure, the boss 2 moves downward, so that the boss 2 at the opening is in contact with a lower surface of a groove 3, thereby achieving a single-side seal of the lower surface.

### Embodiment 2

Similar to Embodiment 1, the difference is that the thickness of the piston ring main body at the groove side is less than the maximum thickness of the piston ring main body 1. The thickness of the piston ring main body 1 at the groove side from the lower surface to the top surface is increased linearly from the position of the opening 4 to an arc length position corresponding to a −90° central angle. Referring to FIG. 5, after the piston ring is assembled, in the working process, when the piston ring is subjected to a pressure of a high-pressure gas from a combustion chamber, the piston ring, the piston ring is pushed to be pressed on a ring bank of a ring groove; and since one side of a groove 3 of the piston ring main body has a slightly smaller thickness, after being subjected to the air pressure, the groove 3 moves downward, so that the boss 2 at the opening 4 is in contact with an upper surface of the groove 3, thereby achieving a single-side seal of the upper surface.

The above embodiments only express several embodiments of the utility model, and the description thereof is more specific and detailed. However, these embodiments cannot be construed as a limitation to the patent scope of the utility model. It should be pointed out that several variations and improvements may be made by those of ordinary skill in the art without departing from the conception of the utility model, but such variations and improvements should fall within the protection scope of the utility model. Therefore, the patent protection scope of the utility model should be subject to the appended claims.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A piston ring for use in a piston ring groove of a piston, the piston ring comprising:
a piston ring main body with an opening;
at least one trapezoidal boss disposed at one end of the opening on the piston ring main body; and
at least one groove disposed at other end of the opening on the piston ring main body, the groove being shaped to correspond with the trapezoidal boss;
wherein a height of the trapezoidal boss is not greater than a depth of the groove; and
wherein the piston ring main body has a first width on one side of the opening that is different from a second width on the opposite side of the opening, such that during engine operation, only one side surface of the trapezoidal boss contacts a corresponding side surface of the groove.

2. The piston ring according to claim 1, wherein a width of the piston ring main body is at a minimum at a position adjacent to the opening and increases linearly to a full width of the piston ring main body at a position corresponding to an arc length between 60° and 180°, measured from the position adjacent to the opening or an arc length between −60° and −180°, measured from the position adjacent to the opening.

3. The piston ring according to claim 2, wherein a width of the piston ring main body adjacent to the trapezoidal boss is less than a width of the piston ring main body adjacent to the groove.

4. The piston ring according to claim 3, wherein a top surface of the piston ring main body adjacent to a side of a combustion chamber is a flat surface, and the width of the piston ring main body increases linearly from a lower surface of the piston ring main body adjacent to the trapezoidal boss to a position of the top surface corresponding to an arc length between 60° and 150°, measured from the lower surface adjacent to the trapezoidal boss.

5. The piston ring according to claim 4, wherein the width of the piston ring main body increases linearly from the lower surface of the piston ring main body adjacent to the trapezoidal boss to a position of the top surface corresponding to an arc length of 90°, measured from the lower surface adjacent to the trapezoidal boss.

6. The piston ring according to claim 2, wherein a width of the piston ring main body adjacent to the groove is less than a width of the piston ring main body adjacent to the trapezoidal boss.

7. The piston ring according to claim 6, wherein a top surface of the piston ring main body adjacent to a side of a combustion chamber is a flat surface, and the width of the piston ring main body increases linearly from a lower surface of the piston ring main body adjacent to the groove to a position of the top surface corresponding to an arc length between −60° and −150°, measured from the lower surface adjacent to the groove.

8. The piston ring according to claim 7, wherein the width of the piston ring main body increases linearly from the lower surface of the piston ring main body adjacent to the groove to a position of the top surface corresponding to an arc length of −90°, measured from the lower surface of the piston ring main body adjacent to the groove.

9. The piston ring according to claim 2, wherein a width of the trapezoidal boss is at least half of the full width of the piston ring main body.

10. The piston ring according to claim 2, wherein a gradual bottom surface portion of the piston ring main body is obtained by at least one of grinding or electro corrosion process.

11. A piston ring for use in a piston ring groove of a piston, the piston ring comprising:
a piston ring main body with an opening;
at least one trapezoidal protrusion disposed at one end of the opening on the piston ring main body; and
at least one trapezoidal recess disposed at other end of the opening on the piston ring main body, the trapezoidal recess being shaped to correspond with the trapezoidal protrusion;
wherein a height of the trapezoidal protrusion is not greater than a depth of the trapezoidal recess; and
wherein the piston ring main body has a first width on one side of the opening that is different from a second width on the opposite side of the opening, such that during engine operation, only one side surface of the trapezoidal protrusion contacts a corresponding side surface of the trapezoidal recess.

12. The piston ring according to claim 11, wherein a width of the piston ring main body is at a minimum at a position adjacent to the opening and increases linearly to a full width of the piston ring main body at a position corresponding to an arc length between 60° and 180°, measured from the position adjacent to the opening or an arc length between −60° and −180°, measured from the position adjacent to the opening.

13. The piston ring according to claim 12, wherein a width of the piston ring main body adjacent to the trapezoidal protrusion is less than a width of the piston ring main body adjacent to the trapezoidal recess.

14. The piston ring according to claim 13, wherein a top surface of the piston ring main body adjacent to a side of a combustion chamber is a flat surface, and the width of the piston ring main body increases linearly from a lower surface of the piston ring main body adjacent to the trapezoidal protrusion to a position of the top surface corresponding to an arc length between 60° and 150°, measured from the lower surface adjacent to the trapezoidal protrusion.

15. The piston ring according to claim 14, wherein the width of the piston ring main body increases linearly from the lower surface of the piston ring main body adjacent to the trapezoidal protrusion to a position of the top surface corresponding to an arc length of 90°, measured from the lower surface adjacent to the trapezoidal protrusion.

16. The piston ring according to claim 12, wherein a width of the piston ring main body adjacent to the trapezoidal recess is less than a width of the piston ring main body adjacent to the trapezoidal protrusion.

17. The piston ring according to claim 16, wherein a top surface of the piston ring main body adjacent to a side of a combustion chamber is a flat surface, and the width of the piston ring main body increases linearly from a lower surface of the piston ring main body adjacent to the trapezoidal recess to a position of the top surface corresponding to an arc length between −60° and −150°, measured from the lower surface adjacent to the trapezoidal recess.

18. The piston ring according to claim 17, wherein the width of the piston ring main body increases linearly from the lower surface of the piston ring main body adjacent to the trapezoidal recess to a position of the top surface corresponding to an arc length of −90°, measured from the lower surface of the piston ring main body adjacent to the trapezoidal recess.

19. The piston ring according to claim 12, wherein a width of the trapezoidal protrusion is at least half of the full width of the piston ring main body.

20. The piston ring according to claim 12, wherein a gradual bottom surface portion of the piston ring main body is obtained by at least one of grinding or electro corrosion process.
